(19) United States
(12) Patent Application Publication
(10) Pub. No.: US 2026/0299582 A1
(43) Pub. Date: Oct. 1, 2026

(54) MONOCULAR FIRST-PERSON-VIEW (FPV) UNMANNED AIRCRAFT SYSTEM (UAS) CONTROL SYSTEM AND METHOD

(71) Applicant: Argus Industrial, LLC., Moon Township, PA (US)

(72) Inventors: Samuel G. Brown, Sandersville, GA (US); Adam Ambriz, Mooresville, NC (US); Eric B. Mitchell, Acworth, GA (US)

(21) Appl. No.: 19/635,342

(22) Filed: Mar. 31, 2026

Related U.S. Application Data
(60) Provisional application No. 63/781,824, filed on Apr. 1, 2025.

(51) Int. Cl. G05D 1/224; G02B 27/01; H04N 7/18

(52) U.S. Cl. CPC G05D 1/2249; G02B 27/0172; G02B 27/0176; H04N 7/185

(57) ABSTRACT

A monocular first-person-view (FPV) viewing system for controlling a remotely piloted vehicle with a camera configured to capture a live video feed includes a head-mounted display module. The head-mounted display module includes a monocular display configured to present the live video feed from the camera of the remotely piloted vehicle to a first viewing eye of an operator while leaving a second unobstructed eye of the operator unobstructed. A receiver module is configured to receive the live video feed from the camera on the remotely piloted vehicle. A module adapter is configured to accept a video signal from the receiver module and send the video signal to the monocular display of the head-mounted display module. A power supply is configured to provide power to the receiver module, the module adapter and the monocular display on the head-mounted display module.

### CROSS-REFERENCE TO RELATED APPLICATIONS

This application claims benefit to U.S. Provisional Patent Application No. 63/781,824 filed on Apr. 1, 2025, entitled MONOCULAR FIRST-PERSON-VIEW (FPV) UNMANNED AIRCRAFT SYSTEM (UAS) CONTROL SYSTEM AND METHOD, which is incorporated by reference in its entirety.

### FIELD OF THE DISCLOSURE

The present disclosure relates generally to the field of remote vehicle operation and wearable displays. Specifically, it relates to a head-mounted monocular display system that allows an operator to view a live video feed from a drone while maintaining ambient situational awareness and visual line-of-sight.

### BACKGROUND

Generally speaking, an unmanned aerial vehicle (UAV) is defined as a “powered, aerial vehicle that does not carry a human operator, uses aerodynamic forces to provide vehicle lift, can fly autonomously or be piloted remotely, can be expendable or recoverable, and can carry a lethal or nonlethal payload”. Many terms are used for aircraft which fly without any persons on board. UAV is a term that is commonly applied to military use cases. Missiles with warheads are generally not considered UAVs because the vehicle itself is a munition, but certain types of propeller-based missile are often called “kamikaze drones” by the public and media. The US FAA now defines any unmanned flying craft as a UAV regardless of weight. Similar terms are remotely piloted aircraft (RPA) and remotely piloted aerial vehicle (RPAV).

UAVs or RPAVs can also be seen as a component of an unmanned aircraft system (UAS), which also includes a ground-based controller and a system of communications with the aircraft. The term UAS was adopted by the United States Department of Defense (DoD) and the United States Federal Aviation Administration (FAA). The term UAS emphasizes the importance of elements other than the aircraft. It includes elements such as ground control stations, data links and other support equipment. Similar terms are unmanned aircraft vehicle system (UAVS) and remotely piloted aircraft system (RPAS). Many similar terms are in use.

In common usage, “drone” is often applied to both military and civilian UAVs, while technical and regulatory documents may prefer terms such as UAV, UAS, RPAS, or uncrewed aircraft. The term drone has been used from the early days of aviation, some being applied to remotely flown target aircraft, and still remains in common use. In addition to the software, autonomous drones also employ a host of advanced technologies that allow them to carry out their missions without human intervention, such as cloud computing, computer vision, artificial intelligence, machine learning, deep learning, and thermal sensors. For recreational uses, an aerial photography drone is an aircraft that has first-person video, autonomous capabilities, or both. The term “Uncrewed” is sometimes used rather than “unmanned” when referring to UAVs.

First-person-view (FPV), also known as remote-person view (RPV), or video piloting, is a method used to control a remote-controlled vehicle from the driver or pilot's viewpoint. Most commonly it is used to pilot a radio-controlled aircraft or other type of unmanned aerial vehicle (UAV) such as a military drone. The operator gets a first-person perspective from an onboard camera that feeds video to FPV goggles or a monitor. More sophisticated setups include a pan-and-tilt gimbaled camera controlled by a gyroscope sensor in the pilot's goggles and with dual onboard cameras, enabling a true stereoscopic view.

Traditional first-person-view (“FPV”) drone operation systems utilize binocular goggles that fully obstruct both eyes of the operator. While immersive, these systems create a “tunnel vision” effect that prevents the operator from maintaining situational awareness of their surroundings. This configuration often requires the operator to remove or reposition the goggles to visually monitor the vehicle or the environment, which is hazardous in professional or tactical scenarios. Furthermore, many existing systems lack hardware modularity, forcing operators into closed ecosystems regarding receiver hardware.

The instant disclosure may be designed to address at least certain aspects of the problems or needs discussed above by providing a monocular first-person-view (“FPV”) unmanned aircraft system (“UAS”) control system and method.

### SUMMARY

The present disclosure may solve the aforementioned limitations of the currently available first-person view (“FPV”) drone or UAS operations, by providing the disclosed monocular first-person-view (“FPV”) unmanned aircraft system (“UAS”) control system and method. The disclosed monocular first-person-view (“FPV”) unmanned aircraft system (“UAS”) control system and method may be used for controlling any remotely piloted vehicle with a camera configured to capture a live video feed. As such, the disclosed monocular first-person-view (“FPV”) unmanned aircraft system (“UAS”) control system may be referred to herein generally as a monocular first-person-view (FPV) viewing system for controlling a remotely piloted vehicle with a camera configured to capture a live video feed.

The disclosed monocular first-person-view (FPV) viewing system for controlling a remotely piloted vehicle with a camera may generally include a head-mounted display module. The head-mounted display module may include a monocular display configured to present the live video feed from the camera of the remotely piloted vehicle to a first viewing eye of an operator while leaving a second unobstructed eye of the operator unobstructed. A receiver module may be configured to receive the live video feed from the camera on the remotely piloted vehicle. A module adapter may be configured to accept a video signal from the receiver module and send the video signal to the monocular display of the head-mounted display module. A power supply may be configured to provide power to the receiver module, the module adapter and the monocular display on the head-mounted display module.

One feature of the disclosed monocular first-person-view (FPV) viewing system may be that when the operator is controlling the remotely piloted vehicle via a control transmitter while viewing the live video feed with the first viewing eye through the monocular display, the operator may maintain situational awareness through the second unobstructed eye including, but not limited to, maintaining visual line-of-sight of the remotely piloted vehicle and/or the environment around them. Wherein, the monocular first-person-view (FPV) viewing system may be configured to allow the operator to maintain both hands on the control transmitter while seamlessly alternating visual focus between the live video feed and direct observation of the remotely piloted vehicle and/or the environment around them.

In select embodiments of the disclosed monocular first-person-view (FPV) viewing system, the monocular display may include a micro-display. The micro-display of the monocular display may allow the head-mounted display module to be contained within a compact lightweight housing that can be mounted to a helmet, a headband, or a head-mounted frame. In select embodiments, the head-mounted display module may include an adjustable mounting arm configured to allow the head-mounted display module to be moved to either eye and/or to be moved out of a field of view of the operator without removing the system. Wherein, the monocular first-person-view (FPV) viewing system may be configured to enable rapid switching between FPV viewing and direct visual observation.

In select embodiments of the disclosed monocular first-person-view (FPV) viewing system may be the monocular display of the head-mounted display module may include a micro-display with an optical lens magnification assembly. The optical lens magnification assembly may be configured for enlarging and/or focusing the live video feed to the first viewing eye of the operator. In select embodiments, the micro-display of the monocular display may be a compact OLED display or an LCD display combined with the optical lens magnification assembly configured to enlarge and focus the perceived image.

Another feature of the disclosed monocular first-person-view (FPV) viewing system may be that the live video feed presented on the monocular display can include on-screen-display (OSD) data. The OSD data shown on the monocular display may be received from the remotely piloted vehicle. Wherein, the OSD data may be embedded in the live video feed received by the receiver module from the remotely piloted vehicle. In select embodiments, the OSD data presented with the live video feed on the monocular display may include telemetry overlays embedded in the live video feed which may include, but is not limited to, a battery life, a timer, and global positioning coordinates (GPS) of the remotely piloted vehicle.

Another feature of the disclosed monocular first-person-view (FPV) viewing system may be that the receiver module may be configured to generate a signal strength (RSSI) indicator of link quality. Wherein, the signal strength (RSSI) indicator may be included in on-screen-display (OSD) data displayed on the monocular display.

In select embodiment of the disclosed monocular first-person-view (FPV) viewing system, the receiver module may receive analog FPV video data of the live video feed from the camera of the remotely piloted vehicle. In select embodiments, the receiver module may include a receiver interface that can include a standardized 9-pin receiver module header. In select embodiments, the receiver module may operate within the 5.8 GHz frequency band. In select possibly preferred embodiments, the receiver module may be a Fatshark style FPV receiver module.

Another feature of the disclosed monocular first-person-view (FPV) viewing system may be that the receiver module can include a diversity receiver. The diversity receiver may select between multiple interchangeable antennas. In select embodiments, the interchangeable antennas may be connected through SMA or RP-SMA connectors. In select embodiments, the multiple interchangeable antennas may be optimized for 5.8 GHz video transmission. In select embodiments, the interchangeable antennas can include, but are not limited to, omnidirectional antennas, directional antennas, patch antennas, and other antenna types optimized for 5.8 GHz video transmission.

Another feature of the disclosed monocular first-person-view (FPV) viewing system may be that the power supply can include a battery pack. The battery pack may be mounted to a rear portion of a helmet, a headband, a head-mounted frame, or the like. Wherein the rear-mounted battery pack may be configured to counterbalance the head-mounted display module.

Another feature of the disclosed monocular first-person-view (FPV) viewing system may be that the module adapter can include an adapter board configured to interface with the receiver module. In select embodiments, the adapter board can include a standardized 9-pin receiver header configured to accept analog first-person-video (FPV) receiver modules. In select embodiments, the adapter board may be configured to output analog video and audio through a 3.5 mm TRRS connector. Wherein, the adapter board may route analog video signals from the receiver module to the monocular display. In select embodiments, the adapter board may include a voltage regulation circuitry configured to regulate input voltage from the power supply for receiver module operation. Wherein, the adapter board may provide regulated power to the monocular display of the head-mounted display module. In select possibly preferred embodiments, the adapter board may receive power from a lithium-polymer battery providing approximately 7.4 volts output, wherein the voltage regulation circuitry of the adapter board may be configured to supply approximately 5 volts to the monocular display of the head-mounted display module. In select embodiments, the adapter board may include a power input capable of accepting power from the lithium-polymer battery, another DC source, or the like. In select embodiments, the adapter board may include an optional power switch and configurable solder pads for system configuration.

Another feature of the disclosed monocular first-person-view (FPV) viewing system may be that the module adapter may be configured to send the video signal to a compatible display device. Wherein, the compatible display device may be capable of presenting the FPV video feed within the field of view of the operator. The compatible display device may include, but is not limited to, a digital night vision device, a heads-up display, an augmented reality display, the like, and/or any other wearable visual interface. Wherein, the FPV video feed may be displayed directly through the monocular display, projected through an alternate display of the compatible display device, or a combination thereof. Wherein, the monocular first-person-view (FPV) viewing system may be configured for various tactical or defense applications.

In select embodiments of the disclosed monocular first-person-view (FPV) viewing system, the remotely piloted vehicle may be a remotely piloted aerial vehicle of an unmanned aerial system (UAS). In these embodiments, the monocular first-person-view (FPV) viewing system may be configured to operate with the remotely piloted aerial vehicle of the unmanned aerial system (UAS).

In another aspect, the instant disclosure embraces the disclosed monocular first-person-view (FPV) viewing system in any of the various embodiments and/or combinations of embodiments shown and/or described herein.

In another aspect, the instant disclosure embraces a method for controlling a remotely piloted vehicle with a camera configured to capture a live video feed while maintaining situational awareness. The disclosed method for controlling the remotely piloted vehicle may generally include utilizing the disclosed monocular first-person-view (FPV) viewing system in any of the embodiments and/or combinations of embodiments shown and/or described herein. As a result, the disclosed method for controlling the remotely piloted vehicle may generally include the step of providing the disclosed monocular first-person-view (FPV) viewing system for controlling the remotely piloted vehicle in any of the embodiments and/or combinations of embodiments shown and/or described herein, including, but not limited to: the head-mounted display module with the monocular display configured to present the live video feed from the camera of the remotely piloted vehicle to a first viewing eye of an operator while leaving a second unobstructed eye of the operator unobstructed; the receiver module configured to receive the live video feed from the camera on the remotely piloted vehicle; the module adapter configured to accept a video signal from the receiver module and send the video signal to the monocular display of the head-mounted display module; and the power supply configured to provide power to the receiver module, the module adapter and the monocular display on the head-mounted display module. With the provided monocular first-person-view (FPV) viewing system for controlling the remotely piloted vehicle, the disclosed method for controlling a remotely piloted vehicle with a camera configured to capture a live video feed while maintaining situational awareness may further include the steps of: positioning the monocular display to the first viewing eye of the operator; maintaining the second unobstructed eye of the operator unobstructed; and simultaneously viewing the live video feed in the first viewing eye and a visual line-of-sight of the remotely piloted vehicle or the environment in the second unobstructed eye.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a general schematic view of the disclosed monocular first-person-view (“FPV”) control system according to select embodiments of the instant disclosure showing the components that create the complete working system;

FIG. 2 is a side view of the OLED monocular display on its own according to select embodiments of the instant disclosure for use in the disclosed monocular first-person-view (“FPV”) control system;

FIG. 3 is a top view of the analog adapter board on its own for the module adapter according to select embodiments of the instant disclosure for use in the disclosed monocular first-person-view (“FPV”) control system;

FIG. 4 is a side view of the analog adapter board from FIG. 3;

FIG. 5 is a top view of the Fatshark-style analog diversity receiver module on its own according to select embodiments of the instant disclosure for use in the disclosed monocular first-person-view (“FPV”) control system;

FIG. 6 is a side view of the Fatshark-style analog diversity receiver module from FIG. 5;

FIG. 7 is a side view of the Fatshark-style analog diversity receiver module from FIGS. 5 and 6 connected to the analog receiver module adapter board from FIGS. 3 and 4 according to select embodiments of the instant disclosure for use in the disclosed monocular first-person-view (“FPV”) control system;

FIG. 8 shows a perspective view of the disclosed monocular first-person-view (“FPV”) control system according to select embodiments of the instant disclosure showing the complete system, wherein all the components are connected and working together without the enclosures;

FIG. 9 is a top perspective view of the monocular first-person-view (“FPV”) control system according to select embodiments of the instant disclosure mounted onto a traditional night vision helmet mounting system;

FIG. 10 is a side perspective view of the monocular first-person-view (“FPV”) control system from FIG. 9 mounted onto a traditional night vision helmet mounting system;

FIG. 11 is a side perspective view of the monocular first-person-view (“FPV”) control system from FIG. 8 according to select embodiments of the instant disclosure mounted onto a traditional night vision helmet mounting system;

FIG. 12 is a front perspective view of the monocular first-person-view (“FPV”) control system from FIG. 11 mounted onto a traditional night vision helmet mounting system;

FIG. 13 is a side perspective view of the monocular first-person-view (“FPV”) control system from FIG. 11 mounted onto a traditional night vision helmet mounting system with the adjustable mounting arm raised moving the monocular display out of the field of view of the operator;

FIG. 14 is an environment perspective back view of the monocular first-person-view (“FPV”) control system from FIG. 8 mounted onto a headband in use controlling a UAV or drone and the surrounding environment showing the situational awareness view with direct visual line-of-sight or the UAV or drone and the environment; and

FIG. 15 is a sketch of a first-person-view (FPV) from the monocular screen of the disclosed monocular first-person-view (“FPV”) control system according to select embodiments of the instant disclosure displaying the transmitted first-person video from the drone with the telemetry overlays of on-screen display data; and

FIG. 16 is a flow chart of the disclosed method for controlling a remotely piloted vehicle while maintaining situational awareness according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

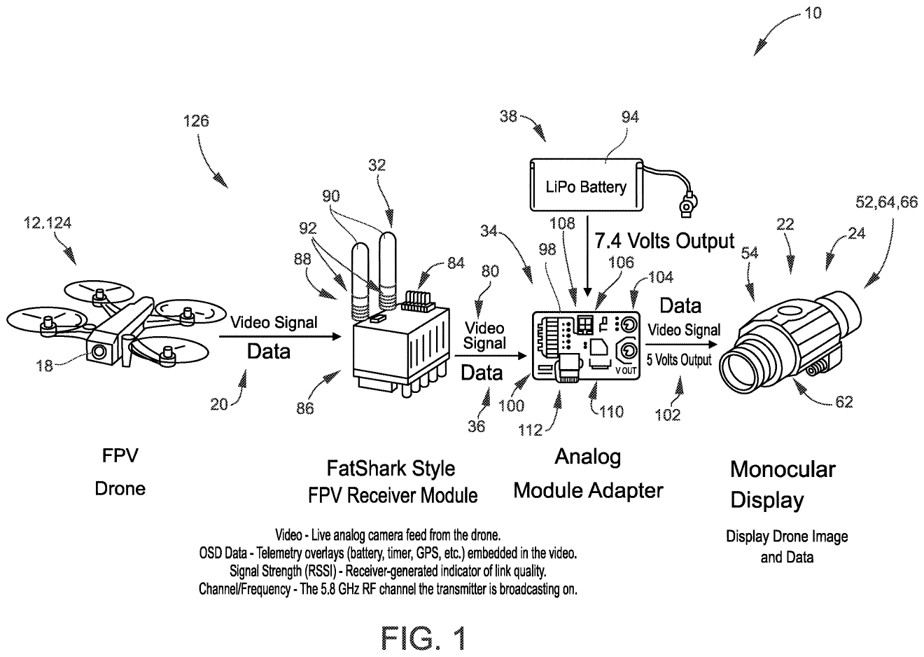

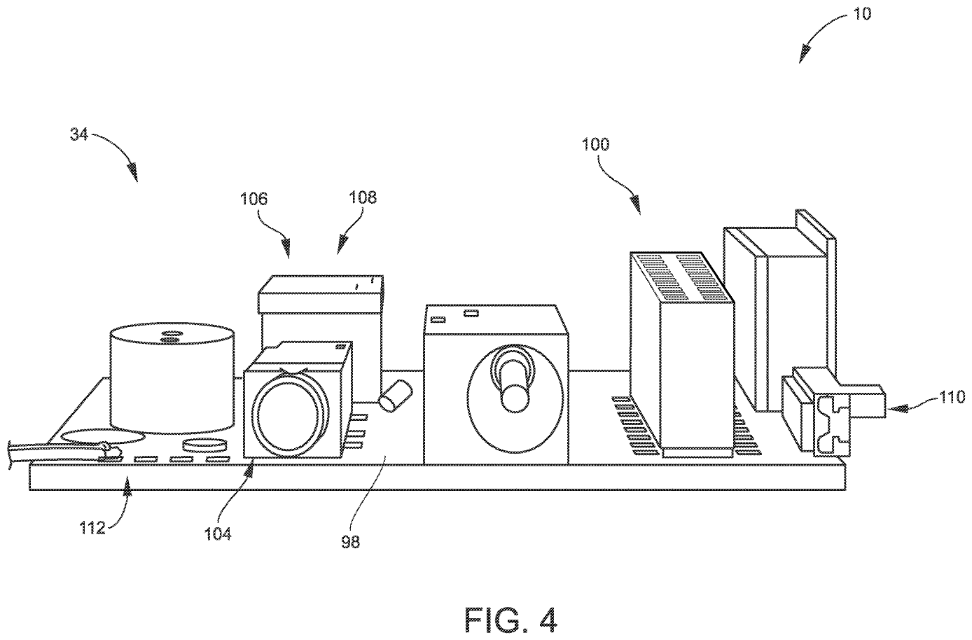

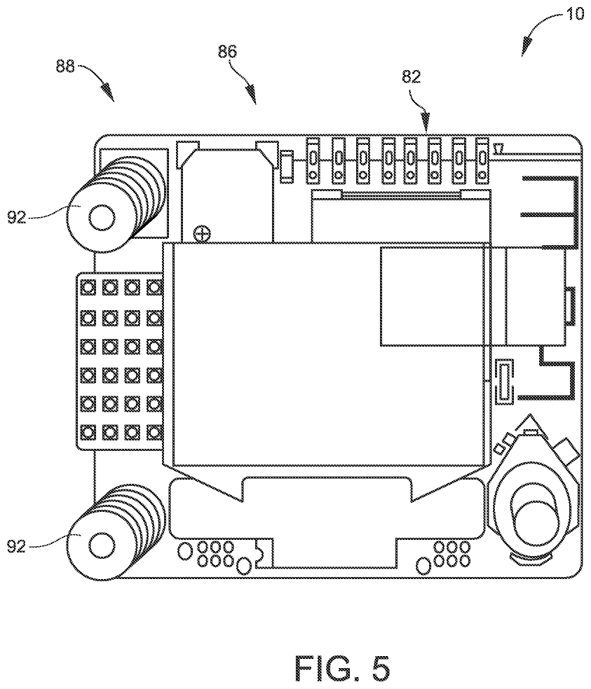

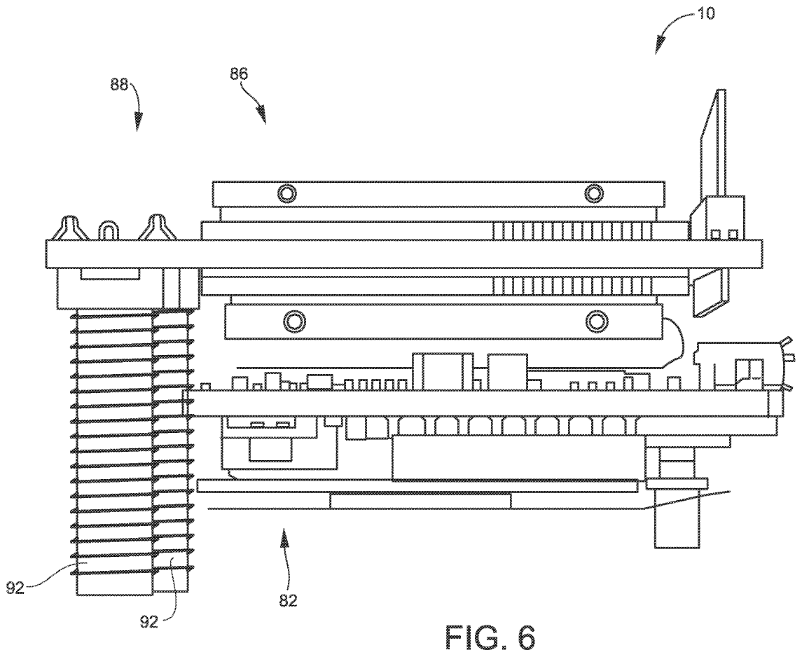

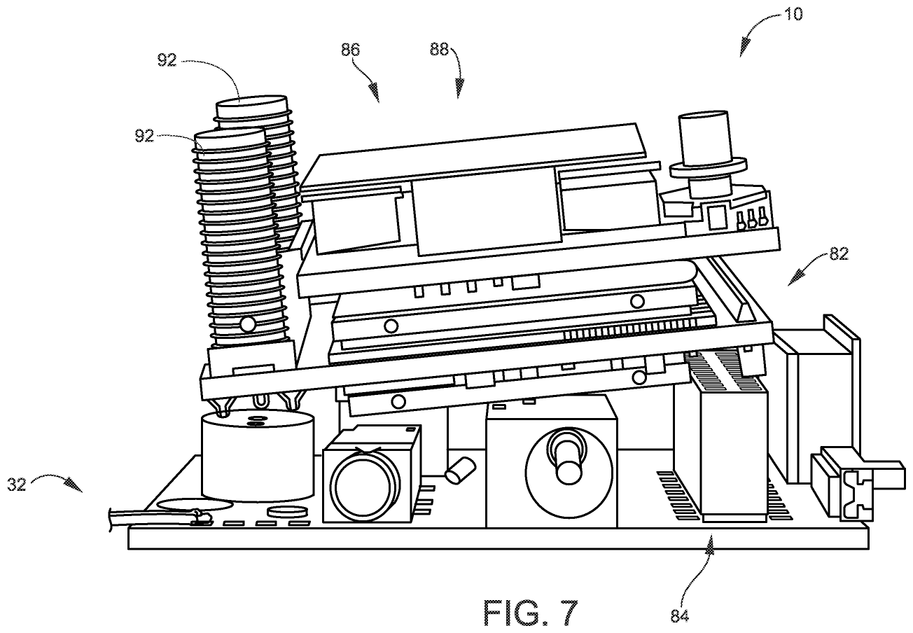

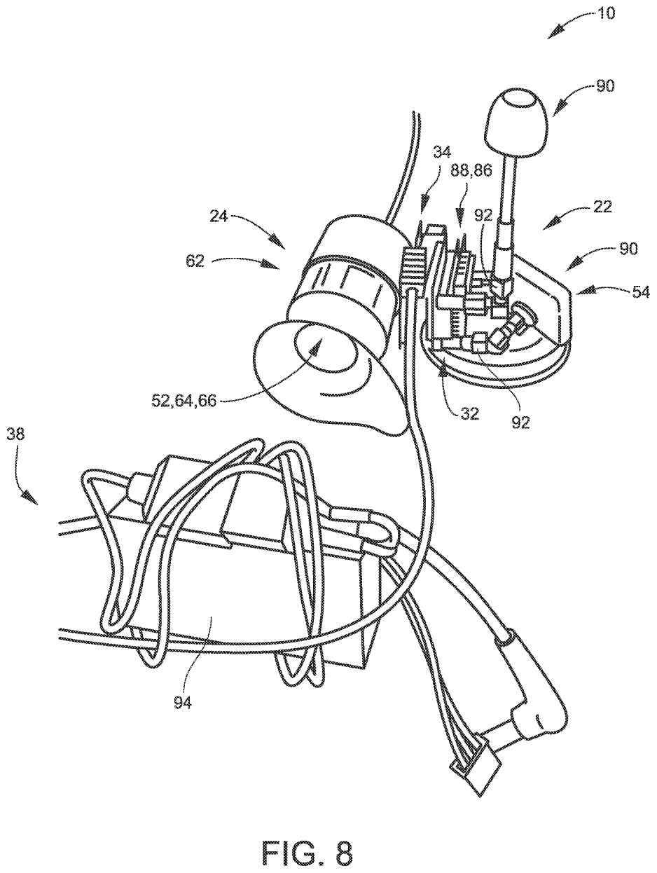

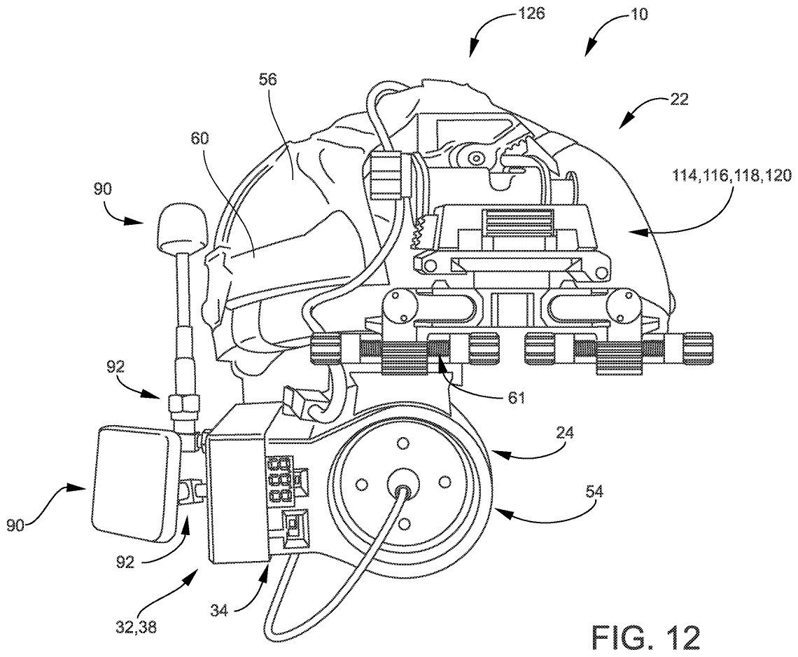

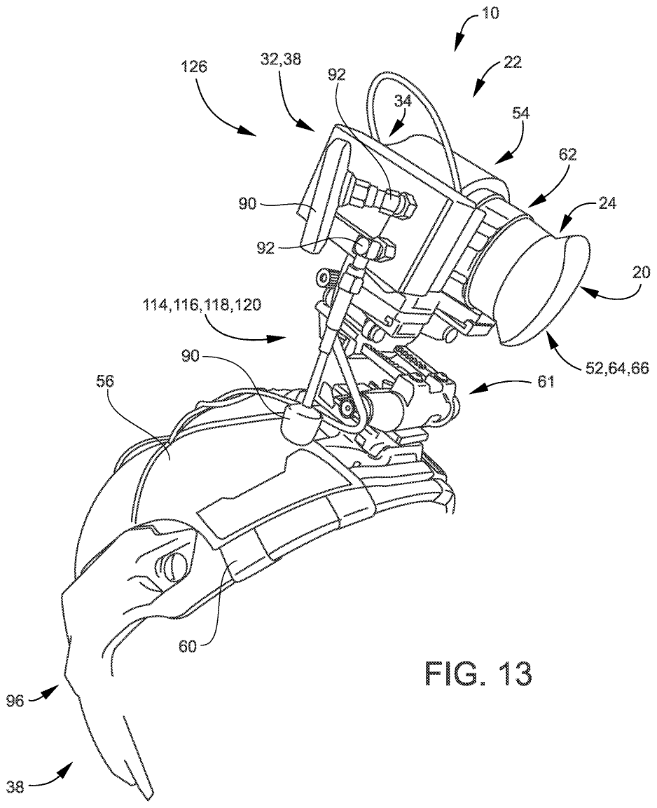

Referring now to FIGS. 1-16, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring to FIGS. 1-16, the present disclosure may solve the aforementioned limitations of the currently available first-person view (“FPV”) drone or UAS operations, by providing the monocular first-person-view (“FPV”) unmanned aircraft system (“UAS”) control system 10 and method 200. The disclosed monocular first-person-view (“FPV”) unmanned aircraft system (“UAS”) control system 10 and method 200 may be used for controlling any remotely piloted vehicle 12 with camera 18 configured to capture live video feed 20 of the operation of the remotely piloted vehicle 12, like a cockpit or driver's seat view of the remotely piloted vehicle 12. As such, the disclosed monocular first-person-view (“FPV”) unmanned aircraft system (“UAS”) control system 10 may be referred to herein generally as monocular first-person-view (FPV) viewing system 10 for controlling remotely piloted vehicle 12 with camera 18 configured to capture live video feed 20.

Referring to FIGS. 1-15, monocular first-person-view (FPV) viewing system 10 for controlling remotely piloted vehicle 12 with camera 18 may generally include head-mounted display module 22, receiver module 32, module adapter 34 and power supply 38. Head-mounted display module 22 may generally include monocular display 24 and may be generally configured to present live video feed 20 from camera 18 of remotely piloted vehicle 12 to first viewing eye 26 of operator 28 while leaving second unobstructed eye 30 of operator 28 unobstructed. Receiver module 32 may be generally configured to receive live video feed 20 from camera 18 on remotely piloted vehicle 12. Module adapter 34 may generally be configured to accept video signal 36 from receiver module 32 and send video signal 36 to monocular display 24 of head-mounted display module 22. Power supply 38 may generally be configured to provide power to receiver module 32, module adapter 34, and monocular display 24 on head-mounted display module 22 for powering the operations and functions of monocular FPV viewing system 10.

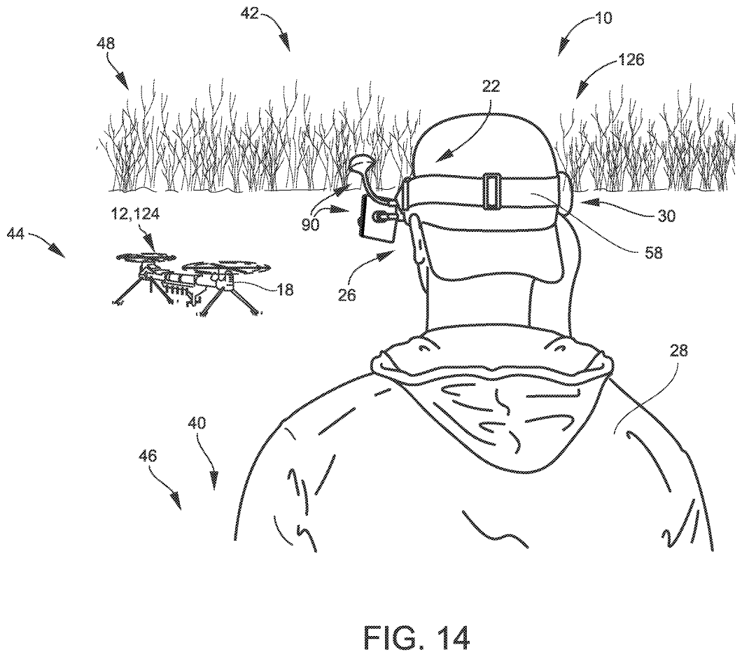

As best shown in FIG. 14, one feature of monocular first-person-view (FPV) viewing system 10 may be that when operator 28 is controlling remotely piloted vehicle 12 via control transmitter 40 (like a remote control or the like), while viewing live video feed 20 with first viewing eye 26 through monocular display 24, operator 28 may maintain situational awareness 42 through second unobstructed eye 30 including, but not limited to, maintaining visual line-of-sight 44 of remotely piloted vehicle 12 and/or environment 48 around them. Wherein, monocular first-person-view (FPV) viewing system 10 may be configured to allow operator 28 to maintain both hands 46 on control transmitter 40 while seamlessly alternating visual focus between live video feed 20 and direct observation of remotely piloted vehicle 12 and/or environment 48 around them.

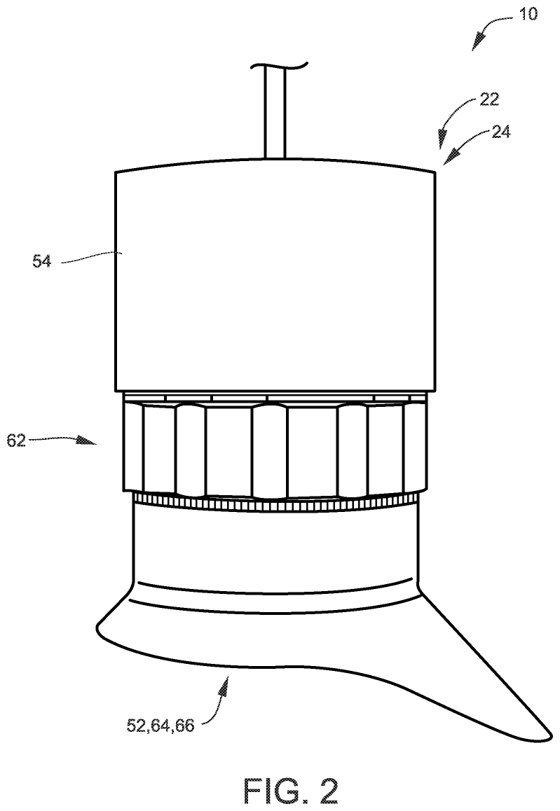

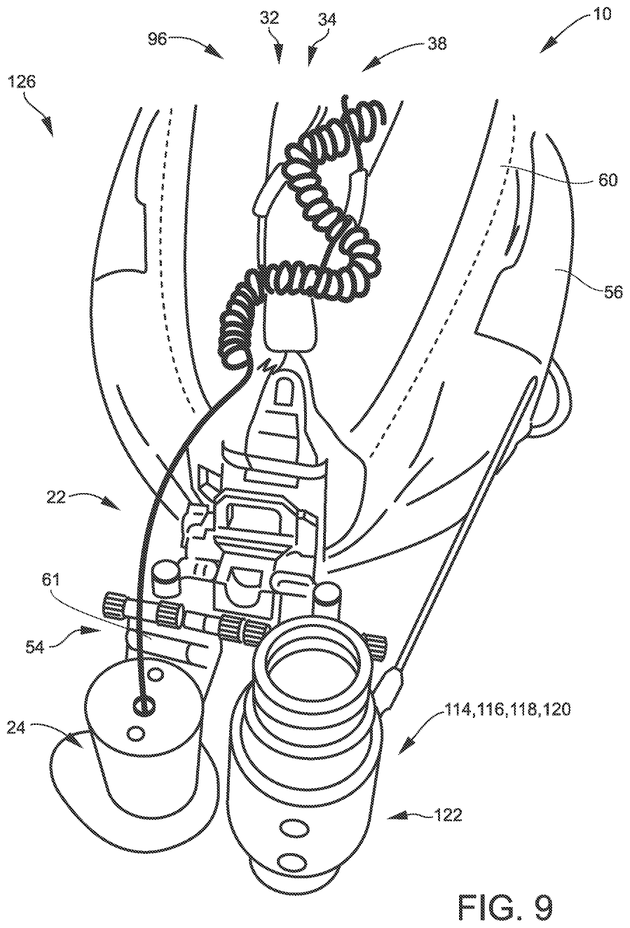

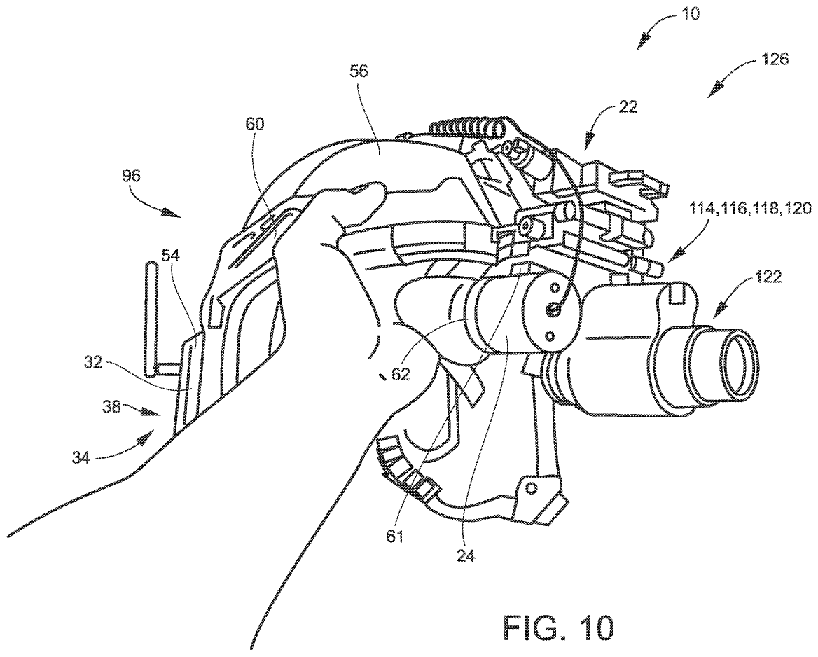

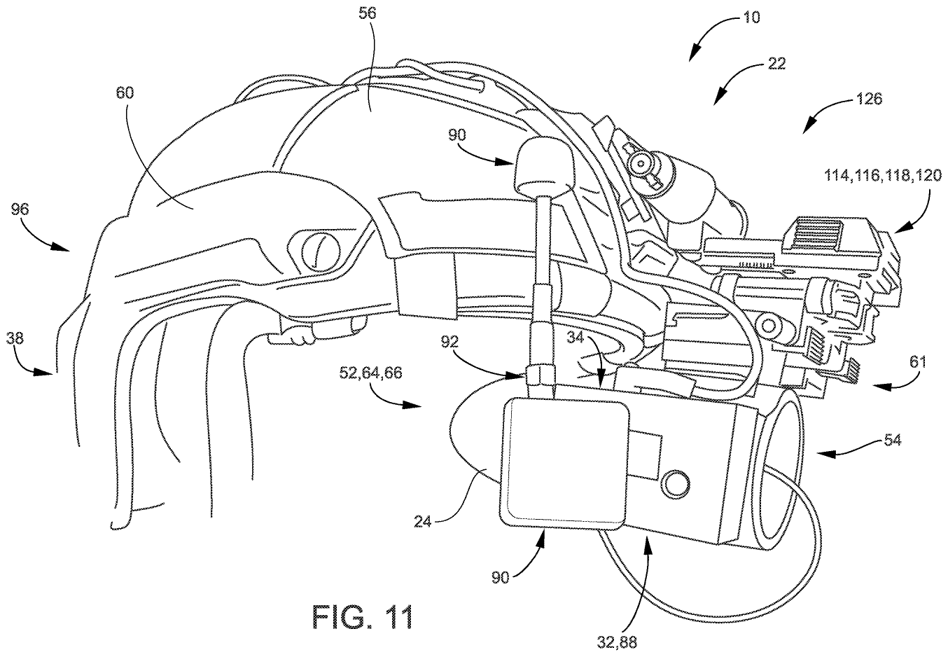

As shown in the FIGS. 1-2, in select embodiments of monocular first-person-view (FPV) viewing system 10, monocular display 24 may include micro-display 52. Micro-display 52 of monocular display 24 may be any display configured to allow head-mounted display module 22 to be contained within compact lightweight housing 54 that can be mounted to helmet 56, headband 58, head-mounted frame 60, or the like. As best shown in FIGS. 9-14, in select embodiments, head-mounted display module 22 may include adjustable mounting arm 61 configured to allow head-mounted display module 22 to be moved to either eye and/or to be moved out of a field of view of operator 28 without removing system 10. Wherein, monocular first-person-view (FPV) viewing system 10 may be configured to enable rapid switching between FPV viewing and direct visual observation of remotely piloted vehicle 12 and/or environment 48. FIGS. 9-10 shows an embodiment of head-mounted display module 22 with antennas 90 mounted on rear portion 96 of helmet 56 with batter pack 94. In this embodiment shown in FIGS. 9-10, the head-mounted display module 22 is included along side of an alternate display 122 on a standard night vision goggles helmet mount on helmet 56 with head-mounted frame 60. The alternate display 122 shown in FIGS. 9-10 may be a compatible display device 114, or a digital night vision device 116, heads-up display 118, augmented reality display 120, or the like. FIGS. 11-13 show a possibly preferred embodiment of head-mounted display module 22 with antennas 90 mounted on the front of the helmet adjacent to monocular display 24. In the embodiment shown in FIGS. 11-13, the head-mounted display module 22 is included by itself on the standard night vision goggles helmet mount on helmet 56 with head-mounted frame 60. In both embodiments shown in FIGS. 9-10 and 11-13, the battery pack 94 is positioned on rear portion 96 of helmet 56 for helping in counter balancing head-mounted display module 22.

As best shown in FIG. 2, in select embodiments of monocular first-person-view (FPV) viewing system 10, monocular display of head-mounted display module 22 may include micro-display 52 with optical lens magnification assembly 62. Optical lens magnification assembly 62 may be configured for enlarging and/or focusing live video feed 20 to the first viewing eye 26 of operator 28. In select embodiments, micro-display 52 of monocular display 24 may be compact OLED display 64 or compact LCD display 66, or the like, combined with optical lens magnification assembly 62 configured to enlarge and focus the perceived image shown by such compact OLED display 64 or compact LCD display 66, or the like.

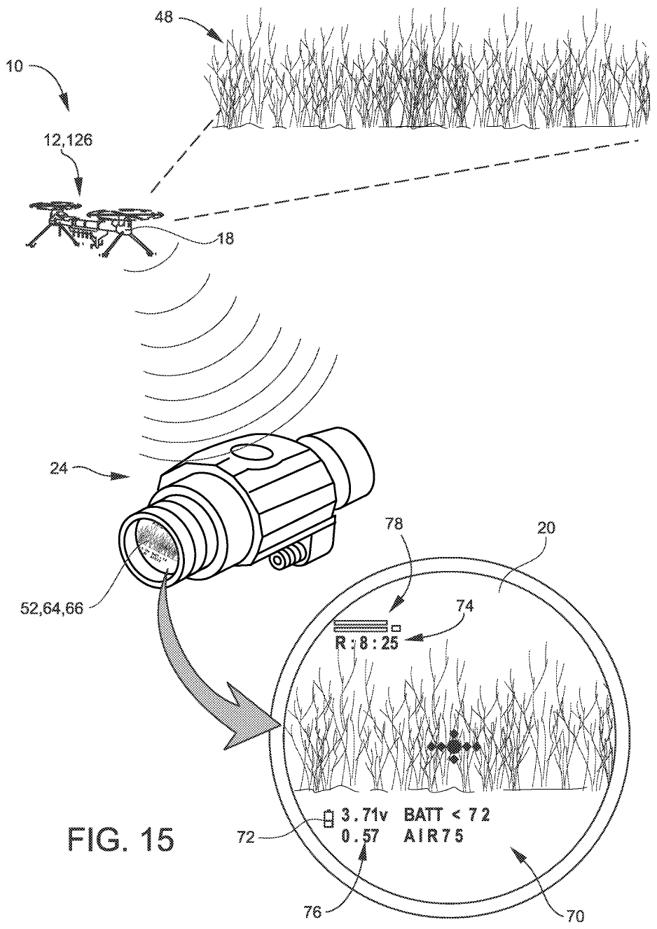

Referring now specifically to FIG. 15, another feature of monocular first-person-view (FPV) viewing system 10 may be that live video feed 20 presented on monocular display 24 can include on-screen-display (OSD) data 68. OSD data 68 shown on monocular display 24 may be received from remotely piloted vehicle 12. Wherein, OSD data 68 may be embedded in live video feed 20 received by receiver module 32 from remotely piloted vehicle 12. In select embodiments, OSD data 68 presented with live video feed 20 on monocular display 24 may include telemetry overlays 70 embedded in live video feed 20 which may include, but is not limited to, battery life 72, timer 74, and global positioning coordinates (GPS) 76 of remotely piloted vehicle 12.

Still referring specifically to FIG. 15, another feature of monocular first-person-view (FPV) viewing system 10 may be that receiver module 32 may be configured to generate signal strength (RSSI) indicator 78 of link quality between camera 18 on remotely piloted vehicle 12 and receiver module 32. Wherein, signal strength (RSSI) indicator 78 may be included in on-screen-display (OSD) data 68 displayed on monocular display 24.

As best shown in FIGS. 1, 5 and 6, in select embodiment of monocular first-person-view (FPV) viewing system 10, receiver module 32 may receive analog FPV video data 80 of live video feed 20 from camera 18 of remotely piloted vehicle 12. In select embodiments, receiver module 32 may include receiver interface 82 that can include standardized 9-pin receiver module header 84. In select embodiments, receiver module 32 may operate within the 5.8 GHz frequency band. In select possibly preferred embodiments, as shown in the Figures, receiver module 32 may be, but is not limited to, a Fatshark style FPV receiver module 86. Another feature of monocular first-person-view (FPV) viewing system 10 may be that receiver module 32 can include diversity receiver 88. Diversity receiver 88 may select between multiple interchangeable antennas 90. In select embodiments, interchangeable antennas 90 may be connected through SMA or RP-SMA connectors 92, or the like. In select embodiments, multiple interchangeable antennas 90 may be optimized for 5.8 GHz video transmission. In select embodiments, interchangeable antennas 90 can include, but are not limited to, omnidirectional antennas 90, directional antennas 90, patch antennas 90, and other antenna types 90 optimized for 5.8 GHz video transmission.

As best shown in FIGS. 1 and 8-13, another feature of monocular first-person-view (FPV) viewing system 10 may be that power supply 38 can include battery pack 94. Battery pack 94 may include any size or type of battery or DC power supply. Battery pack 94 may be mounted to rear portion 96 of helmet 56, headband 58, head-mounted frame 60, or the like. Wherein, rear-mounted battery pack 94 may be configured to counterbalance head-mounted display module 22 when positioned on the head of operator 28.

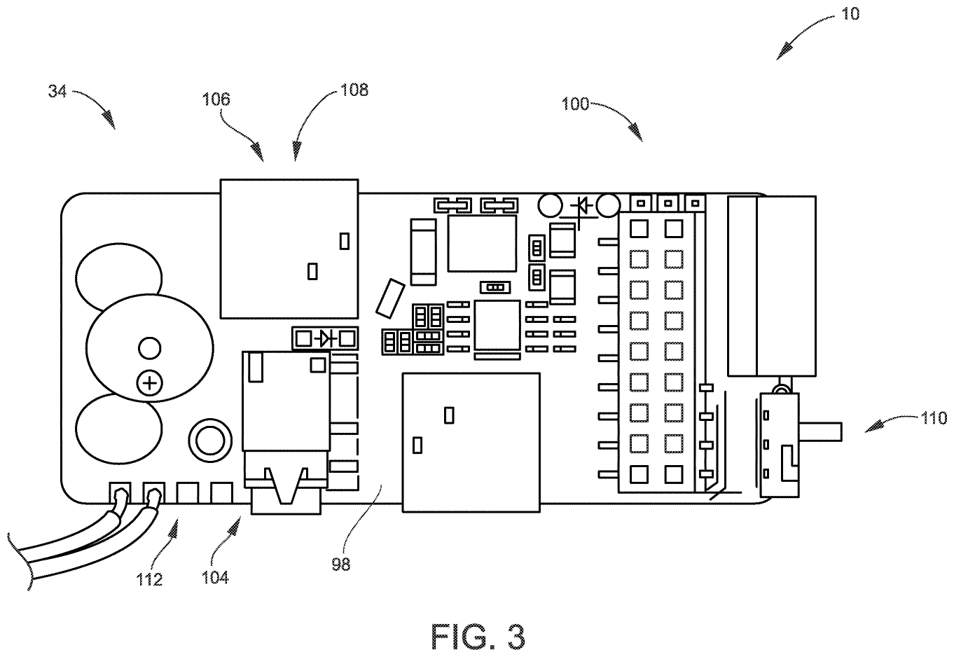

Referring now specifically to FIGS. 3, 4 and 7, another feature of monocular first-person-view (FPV) viewing system 10 may be that module adapter 34 can include adapter board 98. Adapter board 98 may be a printed circuit board (PCB), or the like, configured to interface with receiver module 32. In select embodiments, adapter board 98 of module adapter 34 can include standardized 9-pin receiver header 100 configured to accept various analog first-person-video (FPV) receiver modules. In select embodiments, adapter board 98 may be configured to output analog video and audio 102 through 3.5 mm TRRS connector 104, or the like. Wherein, adapter board 98 may route analog video signals 36 from receiver module 32 to monocular display 24. In select embodiments, adapter board 98 may include voltage regulation circuitry 106 configured to regulate input voltage from power supply 38 for receiver module operation. Wherein, adapter board 98 may provide regulated power to monocular display 24 of head-mounted display module 22. In select possibly preferred embodiments, as shown in the Figures, adapter board 98 may receive power from lithium-polymer battery pack 94 providing approximately 7.4 volts output, wherein voltage regulation circuitry 106 of adapter board 98 may be configured to supply approximately 5 volts to monocular display 24 of head-mounted display module 22. In select embodiments, adapter board 98 may include power input 108 capable of accepting power from the lithium-polymer battery 94, another DC source, or the like. In select embodiments, adapter board 98 may include optional power switch 110 and configurable solder pads 112 for system configuration.

Referring now specifically to FIGS. 9-13, another feature of monocular first-person-view (FPV) viewing system 10 may be that module adapter 34 may be configured to send video signal 36 to compatible display device 114. Wherein, compatible display device 114 may be capable of presenting FPV video feed 20 within the field of view of operator 28. The compatible display device 114 may include, but is not limited to, digital night vision device 116, heads-up display 118, augmented reality display 120, the like, and/or any other wearable visual interface. Wherein, FPV video feed 20 may be displayed directly through monocular display 24, projected through alternate display 122 of compatible display device 114, or a combination thereof. Wherein, the monocular first-person-view (FPV) viewing system may be configured for various tactical or defense applications.

As shown in FIGS. 1, 14 and 15, in select embodiments of monocular first-person-view (FPV) viewing system 10, remotely piloted vehicle 12 may be remotely piloted aerial vehicle 124 of unmanned aerial system (UAS) 126. In these embodiments, monocular first-person-view (FPV) viewing system 10 may be configured to operate with remotely piloted aerial vehicle 124 of unmanned aerial system (UAS) 126.

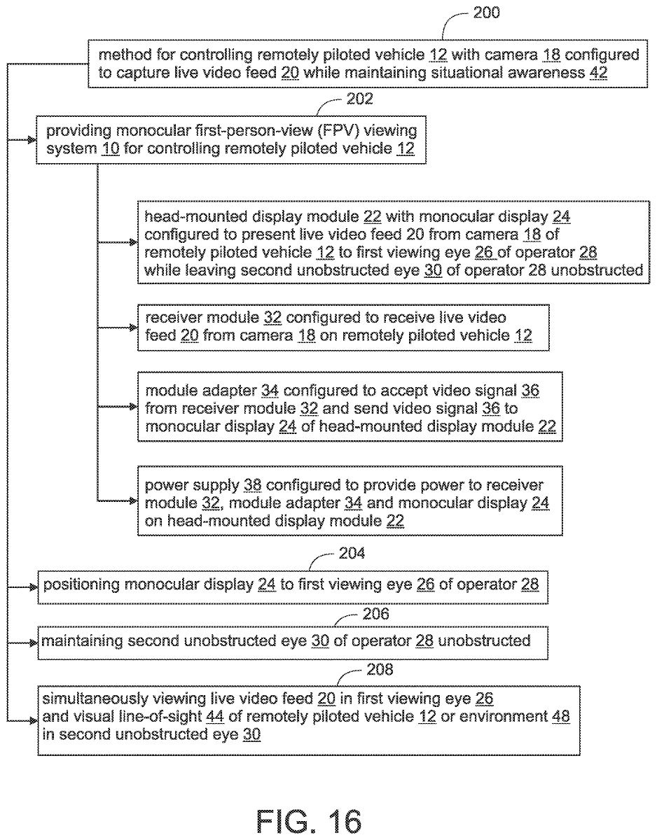

Referring now specifically to FIG. 16, in another aspect, the instant disclosure embraces method 200 for controlling remotely piloted vehicle 12 with camera 18 configured to capture live video feed 20 while maintaining situational awareness 42. Method 200 for controlling remotely piloted vehicle 12, like be remotely piloted aerial vehicle 124 of unmanned aerial system (UAS) 126, may generally include utilizing the disclosed monocular first-person-view (FPV) viewing system 10 in any of the embodiments and/or combinations of embodiments shown and/or described herein. As a result, method 200 for controlling remotely piloted vehicle 12 may generally include step 202 of providing monocular first-person-view (FPV) viewing system 10 for controlling remotely piloted vehicle 12 in any of the embodiments and/or combinations of embodiments shown and/or described herein, including, but not limited to: head-mounted display module 22 with monocular display 24 configured to present live video feed 20 from camera 18 of remotely piloted vehicle 12 to first viewing eye 26 of operator 28 while leaving second unobstructed eye 30 of operator 28 unobstructed; receiver module 32 configured to receive live video feed 20 from camera 18 on remotely piloted vehicle 12; module adapter 34 configured to accept video signal 36 from receiver module 32 and send video signal 36 to monocular display 24 of head-mounted display module 22; and power supply 38 configured to provide power to receiver module 32, module adapter 34 and monocular display 24 on head-mounted display module 22. With the provided monocular first-person-view (FPV) viewing system 10 for controlling remotely piloted vehicle 12, method 200 for controlling remotely piloted vehicle 12 with camera 18 configured to capture live video feed 20 while maintaining situational awareness 42 may further include the steps of: step 204 of positioning the monocular display 24 to the first viewing eye 26 of operator 28; step 206 of maintaining second unobstructed eye 30 of operator 28 unobstructed; and step 208 of simultaneously viewing the live video feed 20 in the first viewing eye 26 and visual line-of-sight 44 of remotely piloted vehicle 12 and/or environment 48 in second unobstructed eye 30.

The present disclosure may relate to viewing systems for remotely piloted aerial vehicles 124 and other remote vehicles 12, particularly systems designed to provide first-person-view (FPV) video feeds 20 to operator 28. System 10 may generally comprise head-mounted monocular display 22 configured to present live video feed 20 from a remote camera 18 to one viewing eye 26 of operator 28. By providing video to only a single eye, the operator's second unobstructed eye 30 remains unobstructed, thereby allowing the operator to maintain environmental situational awareness 42. System 10 may include a modular video receiver architecture configured to receive analog FPV video transmissions from remotely piloted vehicles 12 operating within the 5.8 GHz frequency band. Receiver module 32 may be a removable diversity receiver capable of receiving signals from multiple antennas and selecting or combining signals to improve reception quality. In one embodiment, the receiver module 32 may plug into an analog receiver module adapter board 98 through standardized 9-pin receiver header 84 commonly used in FPV receiver modules. Adapter board 98 may include voltage regulation circuitry 106 configured to provide electrical power and signal routing between receiver module 32 and monocular display system 24. Adapter board 98 may include the following features: 9-pin receiver header 84 configured to accept analog FPV receiver modules; analog video and audio output through a 3.5 mm TRRS connector 104; voltage regulation circuitry 106 configured to regulate input voltage to approximately 5 volts for receiver module operation; power input 108 capable of accepting power from a lithium-polymer battery 94 or other DC source; an optional power switch 110 and configurable solder pads 112 for system configuration; and a regulated 5-volt output configured to power the OLED monocular display 24.

In operation, receiver module 32 may receive an analog FPV video signal from the remotely piloted vehicle 12 and output a decoded analog video signal to the adapter board 98 of module adapter 34. Adapter board 98 may route the video signal to monocular display 24 through a wired connection. Receiver module 32 may include one or more antenna connectors 92 configured to receive interchangeable antennas 90. In certain embodiments, the connectors comprise threaded SMA or RP-SMA connectors 92. Antennas 90 may include omnidirectional antennas, directional antennas, patch antennas, the like, or other antenna types optimized for 5.8 GHz video transmission. In some embodiments, power supply 38 for system 10 may be mounted to rear portion 96 of helmet 56 (or the like) worn by operator 28. This rear-mounted battery pack 94 may power receiver module 32 and monocular display system 24 while counterbalancing the weight of the monocular display 24 located at the front of helmet 56 (or the like). System 10 may be designed to allow operator 28 to continuously operate a drone using a handheld controller 40 while simultaneously observing the FPV feed 20 and maintaining visual line-of-sight awareness 44 of the drone and surrounding environment 48.

### Example

An example of monocular first-person-view (FPV) viewing system 10 was created as shown in FIGS. 1-15. This example of monocular first-person-view (FPV) viewing system 10 included an analog receiver module 32 with adapter board 98 including: 9-pin FatShark receiver header (for analog VRX modules) module 86, analog audio/video output via 3.5 mm TRRS connectors 104, voltage regulation circuitry 106 (down to 5 V) to power receiver module 32, power input 108 from a LiPo or DC source for battery pack 94, optional power switch 110 and solder pads 112, and 5V output to power the OLED monocular screen display 24. The OLED monocular screen 24 was a 0.39-inch micro-OLED display 52 (800×600 resolution) providing a compact, high-definition screen designed for near-eye and miniature display applications. The monocular display 24 with compact lightweight housing 54 was provided with an adjustable focus ring 62 for dialing the clarity of screen 24. Modular diversity receiver 88 of choice was: Immersion RC/Orqa RapidFire (NDAA), Channels: 6 bands, 48 channels (IRC/FatShark, RaceBand, LowRace, Band A, B, E)+custom frequencies, Sensitivity: −96 dBm, Weight: 80 g, Power Consumption: 350 mA @ 5V with both modules enabled, less than 300 mA in low-power mode, and 0.96 ″ monochrome OLED monocular display 24. Interchangeable analog patch and lollipop right hand SMA antennas 90 were used. 2S 7.4V 2S 3000 mAH 5C Lipo Battery 94 with XT 60 to Barrel Connector Extension Cable. 3D printed (PLA+Filament) Enclosures with PVS 14 dovetail to mount onto traditional night vision mounting systems.

In alternative embodiments, the current monocular setup receives an analog video signal. When the technology becomes available, the monocular is aiming to be compatible with digital video signals. In one embodiment, a video receiver may receive a wireless FPV signal and output the decoded analog video through a cable routed to a head-mounted display device. The head-mounted display may be mounted using the headband 58, helmet mount 56, or other attachment mechanism. In another embodiment, the video output from the receiver may be routed to a compatible optical device including a digital night vision device 116, heads-up display 118, augmented reality display 120, or other wearable visual interface capable of presenting the FPV video feed within the operator's field of view. In such embodiments, the FPV video feed 20 may be displayed directly through the monocular display 24 or projected through the alternate display 122 of the compatible display device 114.

A feature of the present disclosure may be its ability to maintain visual line of sight of the drone (UAV or remotely piloted aerial vehicle 124) and/or situational awareness in a stressful environment to ensure their safety, and the safety of those around them.

Another feature of the present disclosure may be its lightweight nature, which minimizes the amount of equipment that the operator must carry.

In sum, the present disclosure may address limitations of the currently available first-person view (“FPV”) drone or UAS operations (or other remotely piloted vehicles and systems) by providing monocular FPV viewing system 10 configured to present the video feed 20 to only one eye of the operator while leaving the other eye unobstructed. This configuration enables operator 28 to simultaneously view the FPV video feed 20 and maintain visual awareness of the surrounding environment 48 and the remotely piloted vehicle 12. The system further provides a modular receiver architecture capable of accepting removable analog video receiver modules through a standardized 9-pin interface. The receiver modules 32 may support diversity reception using multiple antennas 90 connected through interchangeable SMA connectors 92. Adapter board 98 may provide power regulation, video routing, and electrical interfacing between the receiver module 32 and the monocular display 24. System 10 may be powered by an external battery pack 94 mounted to the rear portion 95 of helmet 56 or head-mounted platform to improve weight distribution and reduce fatigue. In certain embodiments, the video output from the receiver may be routed to additional display systems including digital night vision devices 116, heads-up displays (HUDs) 118, augmented reality displays 120, or other wearable visual interfaces. The disclosed system 10 may allow a drone operator to maintain both hands 46 on control transmitter 40 (remote control) during operation while seamlessly alternating visual focus between the FPV video feed 20 and direct observation of the drone or environment 48.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A monocular first-person-view (FPV) viewing system for controlling a remotely piloted vehicle with a camera configured to capture a live video feed comprising:
a head-mounted display module with a monocular display configured to present the live video feed from the camera of the remotely piloted vehicle to a first viewing eye of an operator while leaving a second unobstructed eye of the operator unobstructed;
a receiver module configured to receive the live video feed from the camera on the remotely piloted vehicle;
a module adapter configured to accept a video signal from the receiver module and send the video signal to the monocular display of the head-mounted display module; and
a power supply configured to provide power to the receiver module, the module adapter and the monocular display on the head-mounted display module.

2. The monocular first-person-view (FPV) viewing system of claim 1, wherein, when the operator is controlling the remotely piloted vehicle via a control transmitter while viewing the live video feed with the first viewing eye through the monocular display, the operator maintains situational awareness through the second unobstructed eye including maintaining visual line-of-sight of the remotely piloted vehicle; and
wherein the monocular first-person-view (FPV) viewing system is configured to allow the operator to maintain both hands on the control transmitter while seamlessly alternating visual focus between the live video feed and direct observation of the remotely piloted vehicle or environment.

3. The monocular first-person-view (FPV) viewing system of claim 1, wherein the monocular display including a micro-display, whereby the head-mounted display module with the monocular display is contained within a compact lightweight housing mounted to a helmet, a headband, or a head-mounted frame;
wherein, the head-mounted display module including an adjustable mounting arm configured to allow the head-mounted display module to be moved to either eye and to be moved out of a field of view of the operator without removing the system; and
wherein, the monocular first-person-view (FPV) viewing system is configured to enable rapid switching between FPV viewing and direct visual observation.

4. The monocular first-person-view (FPV) viewing system of claim 1 wherein the monocular display of the head-mounted display module includes a micro-display with an optical lens magnification assembly configured for enlarging and focusing the live video feed to the first viewing eye of the operator; and
wherein, the micro-display of the monocular display is a compact OLED display or an LCD display combined with the optical lens magnification assembly configured to enlarge and focus a perceived image.

5. The monocular first-person-view (FPV) viewing system of claim 1, wherein the live video feed presented on the monocular display including on-screen-display (OSD) data received from the remotely piloted vehicle, wherein the on-screen-display (OSD) data is embedded in the live video feed received by the receiver module from the remotely piloted vehicle.

6. The monocular first-person-view (FPV) viewing system of claim 5, wherein the on-screen-display (OSD) data presented with the live video feed on the monocular display including a telemetry overlays embedded in the live video feed including battery life, a timer, and global positioning coordinates (GPS) of the remotely piloted vehicle.

7. The monocular first-person-view (FPV) viewing system of claim 1, wherein the receiver module is configured to generate a signal strength (RSSI) indicator of link quality, wherein the signal strength (RSSI) indicator is included in on-screen-display (OSD) data displayed on the monocular display.

8. The monocular first-person-view (FPV) viewing system of claim 1 wherein:
the receiver module receives analog FPV video data of the live video feed from the camera of the remotely piloted vehicle;
the receiver module includes a receiver interface including a standardized 9-pin receiver module header; and
the receiver module operates within the 5.8 GHz frequency band.

9. The monocular first-person-view (FPV) viewing system of claim 8, wherein the receiver module is a Fatshark style FPV receiver module.

10. The monocular first-person-view (FPV) viewing system of claim 8 wherein the receiver module comprises a diversity receiver, wherein the diversity receiver selects between multiple interchangeable antennas connected through SMA or RP-SMA connectors, wherein the multiple interchangeable antennas are optimized for 5.8 GHz video transmission, wherein the interchangeable antennas include omnidirectional antennas, directional antennas, patch antennas, and other antenna types optimized for 5.8 GHz video transmission.

11. The monocular first-person-view (FPV) viewing system of claim 1 wherein the power supply includes a battery pack mounted to a rear portion of a helmet, a headband, or a head-mounted frame, wherein the rear-mounted battery pack is configured to counterbalance the head-mounted display module.

12. The monocular first-person-view (FPV) viewing system of claim 1, wherein the module adapter including an adapter board configured to interface with the receiver module, wherein the adapter board includes a standardized 9-pin receiver header configured to accept analog first-person-video (FPV) receiver modules.

13. The monocular first-person-view (FPV) viewing system of claim 12 wherein the adapter board is configured to output analog video and audio through a 3.5 mm TRRS connector, wherein the adapter board routes analog video signals from the receiver module to the monocular display.

14. The monocular first-person-view (FPV) viewing system of claim 12 wherein the adapter board includes a voltage regulation circuitry configured to regulate input voltage from the power supply for operation of the receiver module, wherein the adapter board provides regulated the power to the monocular display of the head-mounted display module.

15. The monocular first-person-view (FPV) viewing system of claim 14, wherein the adapter board receives the power from a lithium-polymer battery providing approximately 7.4 volts output, wherein the voltage regulation circuitry of the adapter board is configured to supply approximately 5 volts to the monocular display of the head-mounted display module; and
wherein, the adapter board including a power input capable of accepting the power from the lithium-polymer battery or another DC source.

16. The monocular first-person-view (FPV) viewing system of claim 12, wherein the adapter board including an optional power switch and configurable solder pads for configuration of the system.

17. The monocular first-person-view (FPV) viewing system of claim 1, wherein the module adapter is configured to send the video signal to a compatible display device;
wherein, the compatible display device is capable of presenting an FPV video feed within a field of view of the operator;
wherein, the compatible display device is selected from a group consisting of: a digital night vision device; a heads-up display; an augmented reality display; and another wearable visual interface;
wherein, the FPV video feed is displayed directly through the monocular display, projected through an alternate display of the compatible display device, or a combination thereof; and
wherein, the monocular first-person-view (FPV) viewing system is configured for tactical or defense applications.

18. The monocular first-person-view (FPV) viewing system of claim 1 wherein the remotely piloted vehicle is a remotely piloted aerial vehicle of an unmanned aerial system (UAS), wherein the monocular first-person-view (FPV) viewing system is configured to operate with the remotely piloted aerial vehicle of the unmanned aerial system (UAS).

19. A monocular first-person-view (FPV) viewing system for controlling a remotely piloted vehicle with a camera configured to capture a live video feed comprising:
a head-mounted display module with a monocular display configured to present the live video feed from the camera of the remotely piloted vehicle to a first viewing eye of an operator while leaving a second unobstructed eye of the operator unobstructed;
the monocular display including a micro-display, whereby the head-mounted display module with the monocular display is contained within a compact lightweight housing mounted to a helmet, a headband, or a head-mounted frame, wherein, the head-mounted display module including an adjustable mounting arm configured to allow the head-mounted display module to be moved to either eye and to be moved out of a field of view of the operator without removing the system, wherein, the monocular first-person-view (FPV) viewing system is configured to enable rapid switching between FPV viewing and direct visual observation;
the monocular display of the head-mounted display module includes the micro-display with an optical lens magnification assembly configured for enlarging and focusing the live video feed to the first viewing eye of the operator, wherein, the micro-display of the monocular display is a compact OLED display or an LCD display combined with the optical lens magnification assembly configured to enlarge and focus a perceived image;
a power supply configured to provide power to a receiver module, a module adapter and the monocular display on the head-mounted display module, the power supply includes a battery pack mounted to a rear portion of the helmet, the headband, or the head-mounted frame wherein the rear-mounted battery pack is configured to counterbalance the head-mounted display module;
the receiver module is configured to receive the live video feed from the camera on the remotely piloted vehicle, wherein:
the receiver module receives analog FPV video data of the live video feed from the camera of the remotely piloted vehicle;
the receiver module includes a receiver interface including a standardized 9-pin receiver module header;
the receiver module operates within the 5.8 GHz frequency band; and
wherein the receiver module is a Fatshark style FPV receiver module;
the receiver module comprises a diversity receiver, wherein the diversity receiver selects between multiple interchangeable antennas connected through SMA or RP-SMA connectors, wherein the multiple interchangeable antennas are optimized for 5.8 GHz video transmission, wherein the interchangeable antennas include omnidirectional antennas, directional antennas, patch antennas, and other antenna types optimized for 5.8 GHz video transmission;
the module adapter is configured to accept a video signal from the receiver module and send the video signal to the monocular display of the head-mounted display module, the module adapter including an adapter board configured to interface with the receiver module, wherein the adapter board includes a standardized 9-pin receiver header configured to accept analog first-person-video (FPV) receiver modules, the adapter board is configured to output analog video and audio through a 3.5 mm TRRS connector, wherein the adapter board routes analog video signals from the receiver module to the monocular display, the adapter board includes a voltage regulation circuitry configured to regulate input voltage from the power supply for operation of the receiver module, wherein the adapter board provides regulated power to the monocular display of the head-mounted display module, the adapter board receives the power from a lithium-polymer battery providing approximately 7.4 volts output, wherein the voltage regulation circuitry of the adapter board is configured to supply approximately 5 volts to the monocular display of the head-mounted display module, wherein, the adapter board including a power input capable of accepting the power from the lithium-polymer battery or another DC source, wherein the adapter board including an optional power switch and configurable solder pads for configuration of the system;
the live video feed presented on the monocular display including on-screen-display (OSD) data received from the remotely piloted vehicle, wherein the on-screen-display (OSD) data is embedded in the live video feed received by the receiver module from the remotely piloted vehicle, wherein the on-screen-display (OSD) data presented with the live video feed on the monocular display including a telemetry overlays embedded in the live video feed including battery life, a timer, and global positioning coordinates (GPS) of the remotely piloted vehicle;
wherein, the receiver module is configured to generate a signal strength (RSSI) indicator of link quality, wherein the signal strength (RSSI) indicator is included in the on-screen-display (OSD) data displayed on the monocular display;
wherein, when the operator is controlling the remotely piloted vehicle via a control transmitter while viewing the live video feed with the first viewing eye through the monocular display, the operator maintains situational awareness through the second unobstructed eye including maintaining visual line-of-sight of the remotely piloted vehicle; and
wherein the monocular first-person-view (FPV) viewing system is configured to allow the operator to maintain both hands on the control transmitter while seamlessly alternating visual focus between the live video feed and direct observation of the remotely piloted vehicle or environment.

20. A method for controlling a remotely piloted vehicle with a camera configured to capture a live video feed while maintaining situational awareness comprising:
providing a monocular first-person-view (FPV) viewing system for controlling the remotely piloted vehicle comprising:
a head-mounted display module with a monocular display configured to present the live video feed from the camera of the remotely piloted vehicle to a first viewing eye of an operator while leaving a second unobstructed eye of the operator unobstructed;
a receiver module configured to receive the live video feed from the camera on the remotely piloted vehicle;
a module adapter configured to accept a video signal from the receiver module and send the video signal to the monocular display of the head-mounted display module; and
a power supply configured to provide power to the receiver module, the module adapter and the monocular display on the head-mounted display module;
positioning the monocular display to the first viewing eye of the operator;
maintaining the second unobstructed eye of the operator unobstructed; and
simultaneously viewing the live video feed in the first viewing eye and a visual line-of-sight of the remotely piloted vehicle or an environment in the second unobstructed eye.
